(19) United States
(12) Patent Application Publication
(10) Pub. No.: US 2025/0010219 A1
(43) Pub. Date: Jan. 9, 2025

(54) DYNAMIC ILLUSION EFFECT FOR A MOVING RIDE VEHICLE

(71) Applicant: Universal City Studios LLC, Universal City, CA (US)

(72) Inventors: Anthony Melo, Orlando, FL (US); Josiah Logan Bender, Winter Park, FL (US); Angelo Pagliuca, Orlando, FL (US)

(21) Appl. No.: 18/642,471

(22) Filed: Apr. 22, 2024

Related U.S. Application Data
(60) Provisional application No. 63/525,335, filed on Jul. 6, 2023.

(51) Int. Cl. A63J 5/02; G02B 26/08; G02B 27/00; G02B 27/14

(52) U.S. Cl. CPC A63J 5/021; G02B 26/0816; G02B 27/0093; G02B 27/144

(57) ABSTRACT

A show effect system for an amusement park may include a display system coupled with a ride vehicle and configured to transition between an extended configuration and a retracted configuration, a screen coupled to the display system, a controller in communication with an actuator, where the actuator may adjust an angle between the screen and the display system. The screen may move with the display system between the extended configuration and the retracted configuration and reflect imagery from the display system in the extended configuration.

### CROSS-REFERENCE TO RELATED APPLICATION

This application claims priority to and benefit of U.S. Provisional Application No. 63/525,335, entitled “DYNAMIC ILLUSION EFFECT FOR A MOVING RIDE VEHICLE,” filed Jul. 6, 2023, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Throughout amusement parks and other entertainment venues, special effects can be used to help immerse guests in the experience of a ride or attraction. Immersive environments may include three-dimensional (3D) props and set pieces, robotic or mechanical elements, and/or display surfaces that present media. For example, amusement parks may provide an augmented reality (AR) and/or a virtual reality experience for guests. The experience may include presenting virtual imagery for guest interaction and the virtual imagery may provide unique special effects for the guests. The special effects may enable the amusement park to provide creative methods of entertaining guests, such as by simulating real world elements or story-telling elements in a convincing manner.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a show effect system for an amusement park may include a display system coupled with a ride vehicle and configured to transition between an extended configuration and a retracted configuration, a screen coupled to the display system, a controller in communication with an actuator, where the actuator may adjust an angle between the screen and the display system. The screen may move with the display system between the extended configuration and the retracted configuration and reflect imagery from the display system in the extended configuration.

In an embodiment, a non-transitory computer-readable medium, includes instructions that, when executed by one or more processors, are configured to cause the one or more processors to perform operations comprising determine one or more characteristics of a guest within a ride vehicle based on sensor data from one or more sensors of a show effect system, receive an initiation signal to transition the show effect system from a retracted configuration to an extended configuration or from the extended configuration to the retracted configuration, and instruct the show effect system to transition. The non-transitory computer-readable medium may instruct the show effect system to transition by activating an actuator to adjust an orientation or a position of a display system based on the sensor data, where adjustment of the display system adjusts an orientation or position of a beam splitter coupled to the display system, generate image data based on the one or more characteristics of the guest, and instruct the display system to project the image data for reflection off the beam splitter based on the image data to cause virtual imagery to be visible to the guest.

In an embodiment, an attraction system within an amusement park may include a show effect system coupled to a ride vehicle. The show effect system may include a beam splitter configured to reflect imagery, a display system coupled to the ride vehicle, an actuator, and the beam splitter, wherein the actuator is configured to transition the display system between a first configuration relative to the ride vehicle and a second configuration relative to the ride vehicle and at least one sensor configured to generate sensor data indicative of at least one characteristic of a guest. The show effect system may also include a controller comprising a memory and a processor, where the controller is communicatively coupled to the show effect system. The controller may determine a line of sight of the guest based on the sensor data, generate image data based on the sensor data, and instruct the display system to present the image data as imagery for reflection off the beam splitter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of an attraction system within an amusement park or theme park, in accordance with an aspect of the present disclosure;

FIG. 2 is a perspective view of an embodiment of the attraction system of FIG. 1 including a ride vehicle and a show effect system, in accordance with an aspect of the present disclosure;

FIG. 3 is a side view of an embodiment of the attraction system of FIG. 1 transitioning between configurations, in accordance with an aspect of the present disclosure;

FIG. 4 is a side view of an embodiment of the attraction system of FIG. 1 including the ride vehicle and the show effect system, in accordance with an aspect of the present disclosure;

FIG. 5 is a side view of an embodiment of the attraction system of FIG. 1 transitioning between configurations, in accordance with an aspect of the present disclosure;

FIG. 6 is a side view of an embodiment of the attraction system of FIG. 1 including the ride vehicle and the show effect system, in accordance with an aspect of the present disclosure; and

FIG. 7 is a flowchart of an embodiment of a method or a process for providing the show effect via the attraction system of FIG. 1, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to providing show effects for an attraction. The attraction may include a variety of features, such as rides (e.g., a roller coaster), theatrical shows, set designs, performers, and/or decoration elements, to entertain guests. Show effects may be used to supplement or complement the features, such as to provide the guests with a more immersive, interactive, and/or unique experience. For example, the show effects may be presented to create the immersive and interactive experience for the guests during a ride.

The attraction system may include a show effect system that presents virtual or simulated objects that may supplement the appearance of real world objects via a Pepper's Ghost system. Conventionally, a Pepper's Ghost system employs a primary area (e.g., a background scene), a secondary area (e.g., augmented reality scene), and an optical beam splitter (e.g., glass, partially reflective film). The optical beam splitter may be arranged to enable transmission of imagery of the primary area through the optical beam splitter. The optical beam splitter may also reflect imagery from the secondary area. As such, the guest may observe imagery from the primary area (e.g., real imagery transmitted from the primary area through the optical beam splitter) and imagery from the secondary area (e.g., virtual imagery reflected from the secondary area off the optical beam splitter) that are combined, superimposed, or overlaid with respect to one another via the optical beam splitter. As such, the show effect system may realistically portray elements of the secondary area such that a viewer perceives them as physically present in the primary area.

Embodiments of the present disclosure are directed to a show effect system coupled to a ride vehicle that utilizes a Pepper's Ghost-based technique to provide a realistic portrayal of elements in the secondary area, as those areas are described above. For example, the ride vehicle may include a viewing port (e.g., window, slot, hole, aperture) for a guest to view show effects (e.g., augmented reality scene). To this end, the ride vehicle may include a show effect system, which may be stored within or coupled to the ride vehicle, that generates virtual imagery for the show effects. During a ride, the show effect system may extend laterally from the ride vehicle to provide the show effect, which may be viewable from the aperture by the guest. The show effect system may include a display system that receives and projects the virtual imagery and a screen that reflects the virtual imagery to a perspective (e.g., line of sight) of the guest. The display system and the screen may be oriented such that virtual imagery appears to the guest with a realistic dimension, apparent depth, points of view, and the like. To bolster this effect, the virtual imagery may include three-dimensional imagery (3D) imagery, which may be generated by a 3D display or multiple 2-dimensional (2D) display systems. Moreover, the virtual imagery may be dynamically adjusted or manipulated during the ride to provide an immersive, interactive, and unique experience for the guest.

The show effect system disclosed herein may provide a realistic show effect to the guest via augmented reality without the need or use of wearable technology, such as a headset or goggles. Thus, operations (e.g., maintenance, cleaning, repair, control of each individual wearable object) and/or costs (e.g., installation costs, maintenance costs) associated with the wearable technology may be avoided while enhancing the experience of the guests. Additionally, the show effect system may be more readily implemented and operated, such as without requiring the guests to equip wearable technology to enable experience of provided show effects.

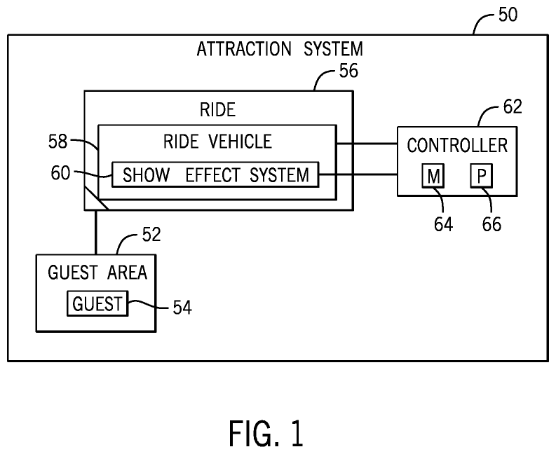

With the preceding in mind, FIG. 1 is a schematic diagram of an embodiment of an attraction system 50 of an amusement park. The attraction system 50 is illustrated as including a guest area 52 with guest(s) 54 positioned therein. The guest area 52 generally represents areas in which guest(s) 54 may be located to experience aspects of the attraction system 50. In an embodiment, the guest area 52 may include an open space, such as a walkable area (e.g., a queue or line) where guests may enter the attraction system 50, exit the attraction system 50, or otherwise navigate through the attraction system 50. As an example, the guest area 52 may include a path (e.g., a walkway, a queue, a line) or open space through which the guest(s) 54 may pass. FIG. 1 also illustrates a ride 56, which may be viewable from or accessible from the guest area 52. In an embodiment, the ride 56 may incorporate the guest area 52. For example, the guest area 52 may include a space (e.g., a seating area) where the guest(s) 54 may be positioned to view a performance or to experience the ride 56 (e.g., while also viewing special effects). Specifically, for example, the guest area 52 may be a seating or standing area within or on a ride vehicle 58 of the ride 56.

The ride 56 may include the ride vehicle 58 and a show effect system 60. The ride 56 may include a roller coaster, a motion simulator, a water ride, a walk through attraction (e.g., a maze), a dark ride, and the like. The ride vehicle 58 may move on a track and carry the guest(s) 54 throughout the ride 56. The ride 56 may include multiple ride vehicle(s) 58 that may be coupled together for one ride cycle. The ride vehicle 58 may include the show effect system 60, which may operate to provide entertainment to the guest(s) 54 during the ride 56. For example, the show effect system 60 may project virtual imagery (e.g., virtual images) to create show effects (e.g., visual effects) that are viewable by the guest(s) 54 from the guest area 52. In another example, the show effect system 60 may determine movements of the guest(s) 54 and update the virtual imagery based on the movements. In addition, the show effect system 60 may receive guest input from one or more guest(s) 54 on the ride 56 and update the virtual imagery based on individual or aggregated guest inputs.

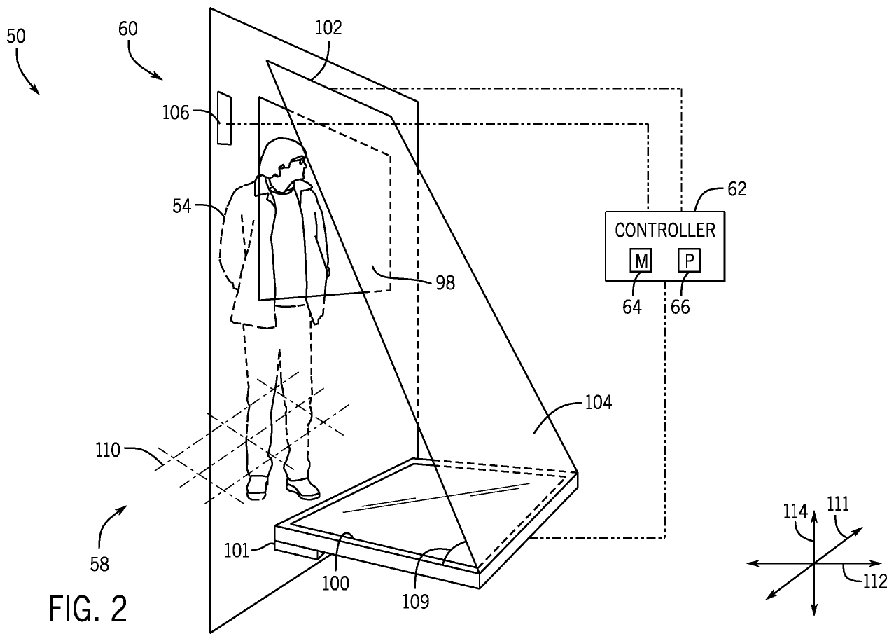

As illustrated with respect to FIG. 2, the show effect system 60 may include a display system that projects virtual imagery to be reflected from a screen to the guest(s) 54 (e.g., aligned with the guest's perspective, along a line of sight of the guest). In an instance, the show effect system 60 may be stored within the ride vehicle 58 during movement of the ride vehicle 58 and/or during loading or unloading of guest(s) 54 to and from the ride vehicle 58. In other instances, the show effect system 60 may retract (e.g., collapse) to be flush against an exterior surface of the ride vehicle 58 to reduce an amount of space occupied by the system 60. Features of the show effect system 60 may extend from the ride vehicle 58 to facilitate and/or enable presentation of the show effects and may retract during movement of the ride vehicle 58 (e.g., to allow for greater ride vehicle mobility, protect features of the show effect system 60). In an embodiment, aspects of the display system 60 may extend from the ride vehicle 58 and a position of the screen may be adjusted such that projected virtual imagery aligns with a guest's perspective. To this end, the show effect system 60 may also include one or more sensors to determine guest attributes, such as height, eye level, position, movement, and the like. The show effect system 60 may use the guest attributes to determine the guest's perspective.

The attraction system 50 may also include or coordinate with a controller 62 (e.g., a control system, an automated controller, a programmable controller, an electronic controller, control circuitry, a cloud-computing system) configured to operate the ride 56, the ride vehicle 58 and/or the show effect system 60 to provide the immersive and/or interactive experience for the guest(s) 54. For example, the controller 62 may be communicatively coupled (e.g., via one or more wires, via wireless communication (e.g., via transmitters, receivers, transceivers)) to one or more components of the show effect system 60. The controller 62 may include a memory 64 and processor 66 (e.g., processing circuitry). The memory 64 may include volatile memory, such as random access memory (RAM), and/or non-volatile memory, such as read-only memory (ROM), optical drives, hard disc drives, solid-state drives, or any other non-transitory computer-readable medium that includes instructions to operate the attraction system 50. The processor 66 may be configured to execute such instructions. For example, the processor 66 may include one or more application specific integrated circuits (ASICs), one or more field programmable gate arrays (FPGAs), one or more general purpose processors, or any combination thereof. In certain instances, the controller 62 may include one or more controllers that are communicatively coupled and may individually or collectively perform actions described herein. Additionally or alternatively, the controller 62 may include one or more processors 66 and/or one or more memories 64 that may individually or collectively perform the actions described herein. Indeed, the illustrated processor 66 and the illustrated memory 64 represent one or more processors and one or more memories, respectively.

The controller 62 may be communicatively coupled to or integrated with the show effect system 60. The controller 62 may control movement of the ride vehicle 58 within the attraction system 50 and/or control various outputs provided by the show effect system 60. For example, the controller 62 may adjust a configuration of the show effect system 60 based on movement of the ride vehicle 58, a location of the ride vehicle 58 within the ride 56, and the like. The controller 62 may provide an initiation signal at certain points of the ride 56, which may cause the show effect system 60 to adjust a position of the display system and the screen and provide the show effect. In addition, the controller 62 may set, adjust, and/or change one or more parameters of image data (e.g., data that defines imagery and that presents as imagery, such as a graphic) to be projected by the show effect system 60, such as to control the appearance of the show effect provided by the show effect system 60. For example, the controller 62 may receive guest input from the guest(s) 54 and generate the image data based on the guest input. In another example, the controller 62 may receive guest input from multiple guest(s) 54 within different ride vehicles 58 during one ride cycle. The controller 62 may aggregate the guest input to generate unified (e.g., fully or partially unified) image data projected by the show effect system 60 to create an immersive experience for the guest(s) 54.

FIG. 2 is a perspective view of an embodiment of attraction system 50 including the ride vehicle 58 and the show effect system 60. The ride vehicle 58 may include a viewing port, such as window 98, for the guest(s) 54 to interact with and/or view the show effects. The window 98 may be made of any suitable material (e.g., glass, plastic) with transmissive properties such that the guest(s) 54 may view the show effects. As illustrated, the guest(s) 54 is standing within the ride vehicle 58 to view the show effects through the window 98. In other instances, the window 98 may be oriented (e.g., lowered to a seated viewing height) such that the guest(s) 54 may look through the window 98 while sitting in the ride vehicle 58.

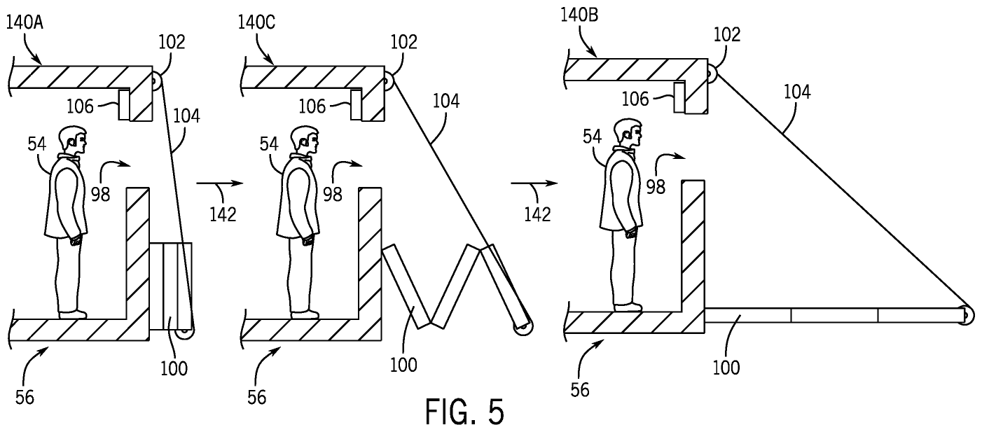

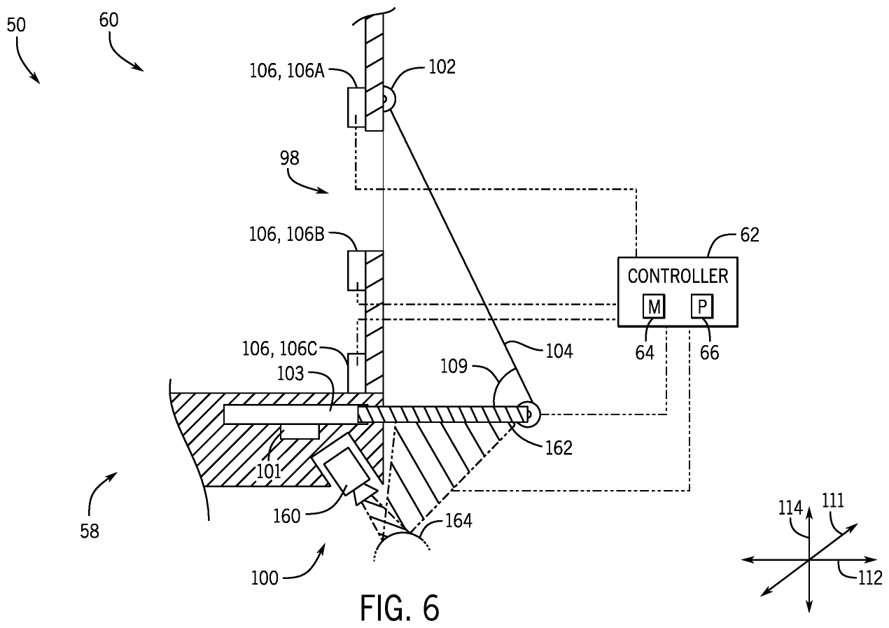

The show effect system 60 may include a display system 100, a pivot 102, a screen 104 (e.g., a beam splitter), and a sensor 106 to provide the show effect to the guest(s) 54. The display system 100 may be any suitable number of displays and/or any suitable type of display (e.g., liquid crystal display (LCD), light emitting diode (LED) display, organic light emitting diode (OLED) display, micro-LED), and/or a projector with a projection screen that receives image data and projects (e.g., displays) the image data as a virtual image. As further described with respect to FIG. 5, the display system 100 may include multiple displays that collectively project the image data to provide the show effect. The display system 100 may also include three-dimensional displays, such as a volumetric display, a light field display, a stereoscopic display, a lenticular display, and the like. For example, the display system 100 may be a television screen that receives image data and projects the image data as virtual imagery. As further described with respect to FIG. 6, the display system 100 may use rear projection with a virtual image source (e.g., projector, display) and a transmissive element.

The display system 100 may receive image data from the controller 62 (or some other data source) and project virtual imagery onto the screen 104 to be viewable by the guest(s) 54 through the window 98. To this end, the screen 104 may be coupled to a distal portion of the display system 100 and about the window 98 of the ride vehicle 58. As illustrated, the screen 104 spans from a first side of the window 98 to a second side of the window 98 to provide the show effects to the guest 54. The screen 104 may include a projection screen that reflects the projected virtual imagery for viewing by the guest(s) 54. The screen 104 may be made of any suitable material, such as glass, plastic, a foil, a semi-transparent mirror, scrim, and/or vinyl, with transmissive and reflective properties. For example, the screen 104 may be made of scrim material and painted to provide reflective properties. In another example, the screen 104 may include a cloth material cured into vinyl with transmissive and reflective properties. Still in another example, the screen 104 may be a beam splitter with both transmissive and reflective properties. In addition, the screen 104 may include flexible properties for the screen 104 to be pushed, pulled, rolled, and the like. For example, the screen 104 may be coupled to the pivot 102, which may facilitate adjusting a position of the screen 104 before, during, and/or after the show effects.

The virtual imagery may be any suitable 2-dimensional (2D) image output by (e.g., projected by) the display system 100. For example, the virtual imagery may be a static image such as a non-changing picture or image. In another example, the virtual image may be a dynamic image and/or video that changes over time. In an additional or alternative embodiment, the virtual image may include a three-dimensional (3D) image that may be static or dynamic. In an embodiment, the display system 100 may include a mechanical figure (e.g., an animated character) that when lit by surrounding or integrated lighting creates a reflection (e.g., virtual imagery) on the screen 104. The display system 100 may be positioned to project the virtual imagery onto the entirety of the screen 104, a portion of the screen 104, a target location of the screen 104, and the like. The virtual imagery may include one or more virtual images projected by the display system 100 that appear in one or more locations as reflected off the screen 104.

The show effect system 60 may generate the show effects based on guest attributes. To this end, the show effect system 60 may include the sensor 106 (e.g., one or more sensors) that detects guest attributes, such as a height of the guest(s) 54, a position of the guest(s) 54, an eye level of the guest(s) 54, a field of view of the guest(s) 54, and the like. The sensor 106 may include a camera (e.g., optical camera, three-dimensional (3D) camera, infrared (IR) camera, depth camera), a position sensor (e.g., sonar sensor, radar sensor, laser imaging, detection, and ranging (LIDAR) sensor), and the like. For example, the sensor 106 may be a camera positioned to monitor the guest(s) 54 and may generate sensor data of the guest(s) 54 during operation of the show effect system 60. As illustrated, the sensor 106 may be between the guest(s) 54 and the window 108. The sensor 106 may generate video data of the guest(s) 54 (e.g., in the IR spectrum, which may not be visible to the guest(s) 54) and transmit the video data to the controller 62. In an embodiment, the sensor 106 may represent multiple sensors positioned in different locations (e.g., multiple locations within the ride vehicle 58) to generate different types of sensor data (e.g., video data, image data) and/or different perspectives of the guest 54.

In an embodiment, the ride vehicle 58 may include markers 110 to facilitate determination of the position of the guest(s) 54. The markers 110 may include infrared (IR) reflective markers, ultra-violet markers, stickers, dots, and the like, which may be detected by the sensor 106. The markers 110 may be disposed at specific locations, such as in a grid pattern on a floor of the ride vehicle 58, and the position of the guest(s) 54 may be determined relative to the specific locations of the markers to facilitate determination of the positioning of the guest(s) 54. That is, the guest(s) 54 may stand within the ride vehicle 58 to view the show effects from the window 108. The position of the guest(s) 54, while standing, may be determined based on a position relative to the markers 110. The guest(s) 54 will block certain of the markers 110 from being detected by the sensor 106. Thus, the lack of detecting certain markers 110 may also provide an indication of location of the guest(s) 54.

The controller 62 may receive and analyze the sensor data to determine a line of sight of the guest(s) 54. For example, the controller 62 may utilize image analysis techniques to determine a height of the guest(s) 54, an eye level of the guest(s) 54, a position of the guest(s) 54, a movement of the guest(s) 54, and the like. The controller 62 may determine if the guest(s) 54 may be looking directly through the window 98 or if the guest(s) 54 may be viewing from an angle through the window 98. In another example, the controller 62 may determine a distance between the guest(s) 54 and the window 98 based on the markers 110. Still in another example, the controller 62 may determine a relative position of the guest's eyes with respect to the window 98. For example, the relative position of a taller guest's eyes may be higher in the vertical direction in comparison to the relative position of a shorter guest's eyes. Determining the line of sight of the guest(s) 54 may include using available sensor data to calculate or estimate an individual guest's line of sight or a line of sight that approximately accounts for numerous guests' data. When determining a single line of sight for numerous of the guest(s) 54, as an example, an approximation or best fit approach may be employed to attempt to accommodate as many guests' views as possible or to accommodate a central line of sight taking into consideration different guest positions.

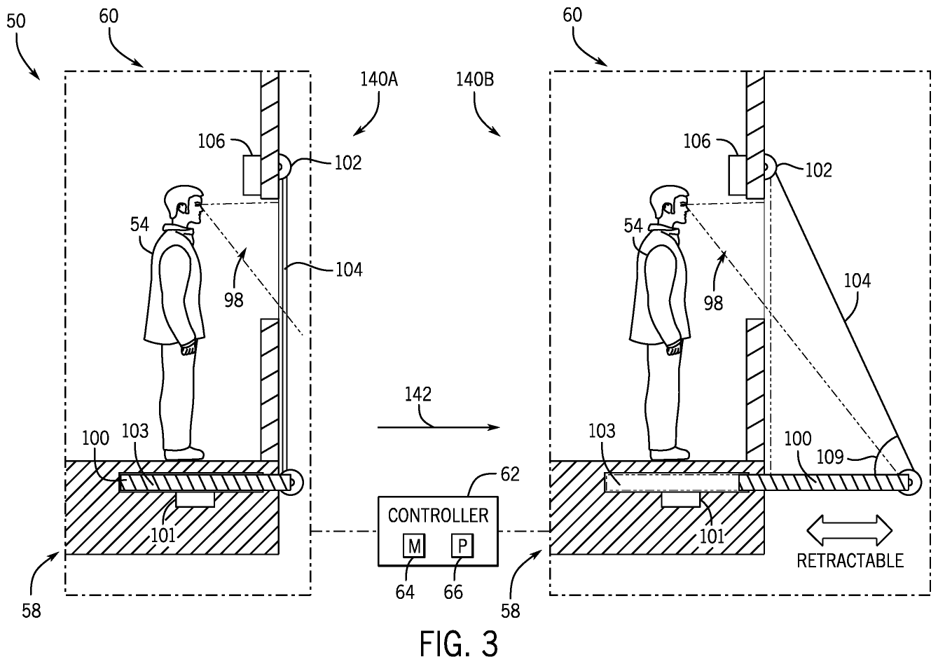

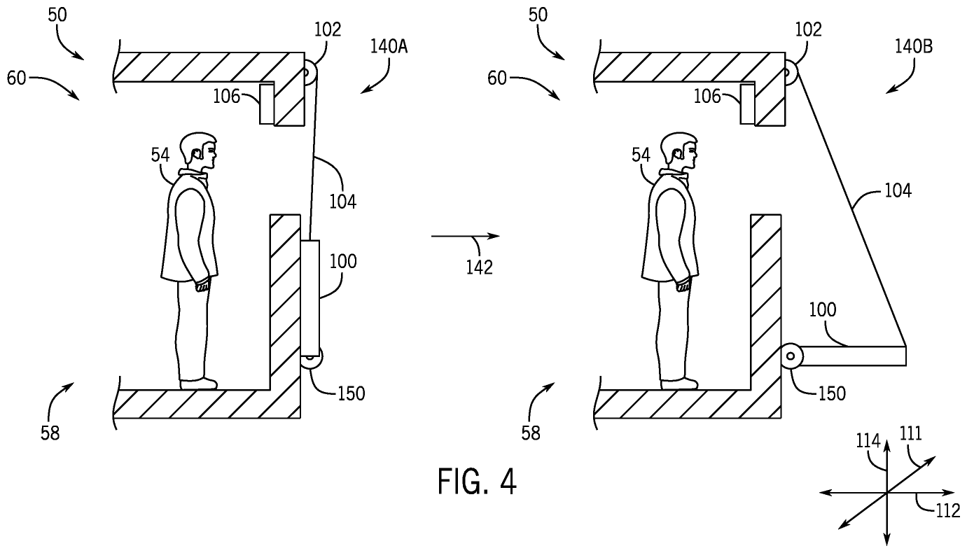

Based on the line of sight, the controller 62 may instruct adjustment of a position of the show effect system 60. For example, the ride vehicle 58 may move in a longitudinal direction 111, such as along a track, to traverse through the ride 56. To generate the show effect, the controller 62 may cause the display system 100 to extend or retract (e.g., in the lateral direction 112) with respect to the ride vehicle 58 by instructing one or more actuator(s) 101. For example, the controller 62 may transmit a signal to adjust a position of the display system 100 and/or the screen 104. The display system 100 may be coupled to an actuator 101 that adjusts the position of the display system 100 (e.g., in the lateral direction 112, in the vertical direction 114) with respect to the ride vehicle 58. For example, as described with respect to FIG. 3, the actuator 101 may extend and retract the display system 100 to and from a storage area within the ride vehicle 58 in the lateral direction 112. As described with respect to FIG. 4, the actuator 101 may retract the display system 100 to be flush with the exterior of the ride vehicle 58 and extend the display system 100 from the ride vehicle 58 to provide the show effects. The actuator 101 may include a linear actuator, a cammed mechanical device, a pneumatic actuator, and the like. In certain instances, the show effect system 60 may include one or more actuator(s) 101 coupled to the display system 100 and configured to extend and/or retract the display system 100 in one or more directions, including rotationally and/or linearly. Such movement may also cause repositioning of the screen 104, which may be coupled to the display system 100.

For example, the controller 62 may instruct adjustment of the position of the screen 104 (e.g., in the vertical direction 114) with respect to the ride vehicle 58. The screen 104 may be coupled to the pivot 102 that moves in the vertical direction 114 with respect to the ride vehicle 58. In other instances, moving the screen 104 may cause the screen 104 (e.g., a partially reflective film) to extend from (or unspool) a spool at the pivot 102 or at the display system 100. The pivot 102 may include a pulley, a slider, a lever, a spool, a roller, a reel, an actuator, and the like. For example, the pivot 102 may move on a track along the exterior surface of the ride vehicle 58. As such, the pivot 102 may include an upper limit at a first side of the ride vehicle 58 and a lower limit at a second side of the ride vehicle 58. For example, the lower limit may be a portion of the window 98 (e.g., an upper edge of the window 98). In another example, the pivot 102 may be an actuator that adjust the position and/or orientation of the screen 104. Still in another example, the pivot 102 may be a spool that extends or retracts the screen 104, thereby adjusting the position and/or orientation. The controller 62 may instruct (e.g., via a control signal) the pivot 102 to adjust a position, thereby adjusting an angle of the screen 104.

In certain instances, the controller 62 may determine an angle 109 between the display system 100 and the screen 104 and adjust the positions based on the angle. Adjusting the angle 109 may cause the virtual imagery to be reflected from the screen 104 at different positions. For example, the angle 109 may be larger when the guest 54 may be taller in comparison to a shorter guest 54. In another example, standing further away from the window 108 may cause the line of sight of the guest 54 to appear lower. As such, the angle 109 may decrease. In this way, visibility of the virtual imagery may be improved. The guest 54 is positioned such that the virtual imagery is reflected from the screen 104 toward the guest(s) 54 in a manner that makes the virtual imagery appear as though it is positioned in the background. For example, moving the pivot 102 upwards in the vertical direction 114 may increase an angle 109 between the screen 104 and the display system 100 and moving the pivot 102 downwards in the vertical direction 114 to decrease the angle 109. In another example, extending the screen 104 from the pivot 102 (e.g., spool) may decrease the angle 109 and retracting the screen 104 into the pivot 102 may increase the angle 109.

Additionally, the controller 62 may receive sensor data indicative of guest input and generate the image data based on the guest input. For example, the sensor data may be indicative of a movement of the guest(s) 54. The controller 62 may analyze the sensor data to determine a movement of the guest(s) 54 and determine if the movement corresponds to one or more stored movements. If the movement does correspond, then the controller 62 may update the image data based on the movement. If the movement does not correspond, then the controller 62 may not update the image data. For example, the virtual imagery may correspond to a request for guest interactions including a digging action or gesture, which if properly performed will unveil a hidden treasure chest graphic. If the controller 62 determines the guest(s) 54 is performing the digging action or gesture, then the controller 62 may update the image data such that the virtual imagery displays the treasure chest graphic.

In certain instances, the ride 56 may include multiple ride vehicles 58 with multiple guest(s) 54. The virtual imagery may be generated based on collected sensor data of each guest 54. For example, the show effect may include imagery indicating a quest for the guest(s) 54 to virtually collect hidden gems. The show effect system 60 may detect guest input from a first guest 54 on a first ride vehicle 58 and guest input from a second guest 54 on a second ride vehicle 58. For example, the first guest 54 may perform actions (e.g., gestures) that correlate to searching and digging for gems while viewing virtual imagery of rocks. The second guest 54 may perform actions (e.g., body positioning) of sitting rather than searching. The controller 62 may receive sensor data indicative of both the first guest 54 and the second guest 54 and update the transmitted virtual imagery. For example, the first guest 54 may view virtual imagery of rocks being flipped and gems appearing. The virtual imagery may also include imagery of the second guest 54 sitting, which may be blurry or out of focus in comparison to the virtual imagery of rocks being flipped. As such, the first guest 54 may perform actions of walking which may appear in the virtual imagery as walking over to the second guest 54 and handing the second guest 54 a shovel. Indeed, the controller 62 may update the virtual imagery such that the second guest 54 may view imagery of the first guest 54. In certain instances, the virtual imagery may include a total number of gems collected by all of the guest(s) 54 on the ride 56 to provide for collaborative gameplay between the guest(s) 54. In this way, the show effect system 60 may create an immersive and/or interactive experience for the guest(s) 54.

FIG. 3 is a side view of an embodiment of the attraction system 50 including the ride vehicle 58 and the show effect system 60. In particular, FIG. 3 illustrates the show effect system 60 transitioning between a first configuration 140A (e.g., retracted configuration) to a second configuration 140B (e.g., extended configuration), wherein the transition is indicated by the arrow 142. For example, the show effect system 60 may be in the first configuration 140A during movement of the ride vehicle 58 and may be in the second configuration 140B when the ride vehicle 58 may be stopped. It may be beneficial to stow the show effect system 60, such as in the first configuration 140A, during movement to centralize the weight and avoid potential damage to the show effect system 60 and/or ride vehicle 58. However, the show effect system 60 may be transitioned between configurations for any of numerous different reasons. For example, the show effect system 60 may be stowed while the ride vehicle 58 navigates a narrow passage and/or the show effect system 60 may be extended to provide a presentation during a particular phase of a ride.

In the first configuration 140A, the show effect system 60 may not generate the show effects. The display system 100 may be positioned within the ride vehicle 58 (e.g., nested within a storage area 103 of the ride vehicle 58) and the screen 104 may be draped along an exterior surface (e.g., lateral side) of the ride vehicle 58. For example, the display system 100 may be stored within a storage area 103 (e.g., receptacle) of the ride vehicle 58 and adjacent to a floor of the ride vehicle 58. The storage area 103 may be a recess within the ride vehicle 58. The storage area 103 may include the actuator 101 that causes the display system 100 to retract within the ride vehicle 58 . . . . In another example, the display system 100 may be coupled beneath the ride vehicle 58, such as between two axles, and retract between the axles. In another example, the pivot 102 may be in a maximum vertical position along the vertical direction 114. The pivot 102 may pull the screen 104 such that the screen may be taught against (e.g., flush with) the exterior surface of the ride vehicle 58. In certain instances, the pivot 102 may include a roller or a wheel to roll (e.g., coil) portions of the screen 104 to cause the retraction. To this end, the screen 104 may be made of a flexible material. In addition, the angle 109 between the screen 104 and the display system 100 may be 90 degrees or greater. In certain instances, the angle between the screen 104 and the guest(s) 54 may be adjusted based on the guest's perspective. For example, to improve visibility of the virtual images, the screen 104 may be positioned at a 45 degree angle with respect to the guest's perspective.

In certain instances, the show effect system 60 may receive a signal (e.g., initiation signal) from the controller 62 indicative of generating the show effect. For example, the ride vehicle 58 may pause and/or stop movement during the ride 56. As such, the show effect system 60 may transition to the second configuration 140B to provide the show effects. The show effect system 60 may cause the display system 100 to extend in the lateral direction 112 from the ride vehicle 58. For example, the controller 62 may determine a position of the display system 100 based on guest attributes and instruct the actuator 101 to adjust the position of the display system 100 in the lateral direction 112. In another example, the controller 62 may instruct the actuator 101 to adjust the position of the display system 100 based on ride 56 attributes, such as tight enclosures that may not allow the display system 100 to fully extend in the lateral direction 112. As such, a portion of the display system 100 may be extended and a remaining portion of the display system 100 may be within the ride vehicle 58. In addition, the controller 62 may determine a position of the pivot 102 and/or the screen based on the guest attributes. For example, the controller 62 may instruct the pivot 102, which may include an actuation mechanism, to move downwards in the vertical direction to adjust the position of the screen 104. In addition, the controller 62 may determine a target angle between the screen 104 and the display system 100. The controller 62 may instruct the pivot 102 to move downwards in the vertical direction to decrease the angle 109, which may improve visibility of the virtual imagery with respect to the guest's perspective.

In certain instances, a portion off the display system 100 may be extended and a portion of the display system 100 may be retracted within the ride vehicle 58. For example, during certain portions of the ride 56, the ride vehicle 58 may be within an enclosure and space on lateral sides (or other sides from which the display system 100 may extend) of the ride vehicle 58 may be limited. As such, extension of only a portion of the display system 100 may be used to project the virtual imagery to provide effects for the guest(s) 54 to view. Though the conditions may not be as specifically tuned for viewing as they would be when full extension is available, limited extension may provide options for providing desired effects in limiting circumstances. To this end, the controller 62 may transmit a control signal to instruct the actuator 101 to extend the display system 100 to a position or by a pre-determined distance.

While the illustrated guest(s) 54 may be standing to view the show effects from the window 98, in other instances, a relative distance between the window and the floor of the ride vehicle 58 may be adjusted. For example, a position of the window 98 may be adjusted by moving a wall of the ride vehicle 58. In another example, the floor of the ride vehicle 58 may be raised or lowered to adjust the position relative distance between the window 98 in the floor. For example, the guest(s) 54 may be a child. As such, the controller 62 may transmit a control signal to an actuator to adjust the distance between the floor and the window 98 such that the guest(s) 54 may view the show effects via the window 98. In another example, the guest(s) 54 may be sitting in the ride vehicle 58 versus standing. As such, the controller 62 may instruct adjustment of the distance between the seat of the ride vehicle 58 and the window 98 such that the guest(s) 54 may turn their head and view the show effects from the window 98.

In an embodiment, rather than retract into and extend from the storage area 103, the display system 100 may fold between different configurations. For example, the display system 100 may fold alongside the ride vehicle 58 in a retracted configuration and fold outward into an extended configuration as shown in FIG. 4. As another example shown in FIG. 5, the display system 100 may transition from a retracted configuration to an extended configuration via an accordion-like actuator.

FIG. 4 is a side view of an embodiment of the attraction system 50 including the ride vehicle 58 and the show effect system 60. In particular, FIG. 4 illustrates the show effect system 60 transitioning between a first configuration 140A (e.g., retracted configuration) to a second configuration 140B (e.g., extended configuration), wherein the transition is indicated by the arrow 142. In the illustrated example, the ride vehicle 58 may not include the storage area 103, rather the display system 100 may fold alongside the ride vehicle 58 in the first configuration 140A and fold outward into the second configuration 140B. To this end, the display system 100 may be coupled to the ride vehicle 58 by an actuator 150. The actuator 150 may be a linear actuator, a cammed mechanical device, a rotational actuator, a hinge, and the like to adjust the position of the display system 100.

In the first configuration 140A, the display system 100 and/or the screen 104 may be adjacent to the exterior surface of the ride vehicle 58. In certain instances, the screen 104 may be retracted within or about the pivot 102, such as if the pivot 102 is a spool. To generate the show effects, the controller 62 may transmit a signal to the actuator 150 to transition the show effect system 60 to the second configuration. For example, the actuator 150 may adjust the position of the display system 100 (e.g., in the lateral direction 112), which may cause the screen 104 to extend from the spool. As such, the show effects may be provided. In other instances, the actuator 150 may be a hinge that supports movement of the display system 100 (e.g., in the lateral direction 112) as the screen 104 extends and/or retracts from the pivot 102.

FIG. 5 is a side view of an embodiment of the attraction system 50 including the ride vehicle 58 and the show effect system 60. For example, the display system 100 may transition from a folded configuration (e.g., first configuration 140A, the retracted configuration) to an extended configuration (e.g., second configuration 140B) via an accordion-like actuation. The display system 100 may transition from the folded configuration to the extended configuration through an intermediate configuration (e.g., a third configuration 140C). As illustrated, the display system 100 may include three displays coupled to the ride vehicle 58.

In the folded configuration, the display system 100 may be folded and flush against the exterior surface of the ride vehicle 58. In the intermediate configuration, the display system 100 may extend in the lateral direction 112 from the ride vehicle 58. In the extended configuration, the display system 100 may align to generate the image data and project the image data off the screen 104.

FIG. 6 is a side view of an embodiment the attraction system 50 including the ride vehicle 58 and the show effect system 60 in accordance with the present disclosure. In the illustrated embodiment, the show effect system 60 includes multiple sensors 106 that generate sensor data based on the guest(s) 54. Further, the illustrated show effect system 60 includes the display system 100 including a rear projector 160, a transmissive element 162, and a reflective element 164.

As illustrated, the show effect system 60 may include three sensors 106 located throughout the ride vehicle 58. As illustrated, a first sensor 106, 106A and a second sensor 106, 106B may be positioned adjacent to the window 98 and may operate to detect guest attributes, such as a height or a position of the guest(s) 54 relative to the window 98. The third sensor 106, 106C may be positioned adjacent to the floor of the ride vehicle 58 and may determine a position of the guest(s) 54 within the ride vehicle 58. In certain instances, the third sensor 106, 106C may be a proximity sensor or an ultrasonic sensor that determines a position of the guest(s) 54 relative to the window 98. The controller 62 may analyze the sensor data to determine information including an identity of the guest(s) 54 (e.g., based on facial recognition) or other attributes of the guest (e.g., identity, height, size, weight, clothing, hairstyles, accessories, tattoos). In addition, the sensors 106 may determine a movement of the guest(s) 54 from different angles and/or perspectives. Indeed, overlapping or layering sensor data may provide robust data to improve image analysis operations.

In an embodiment, the display system 100 may include the rear projector 160, the transmissive element 162, and the reflective element 164. The projector 160 may receive image data from the controller 62 and project virtual imagery to be viewable by the guest(s) 54. For example, the projector 160 may project the virtual imagery onto the reflective element 164. The reflective element 164 may include a curved mirror, a reflective panel, or any suitable element for reflecting the virtual imagery. The projector 160 may directly project the virtual imagery onto the reflective element 164 such that the virtual imagery reflects off the reflective element 164 and through the transmissive element 162. The transmissive element 162 may include an optical beam splitter, a glass panel, and the like. In certain instances, the transmissive element 162 may adjust the virtual imagery, such as refracting, bending, enlarging, and/or reducing light of the virtual imagery. For example, the transmissive element 162 may adjust a position of the virtual imagery as reflected off the screen 104. In another example, the transmissive element 162 may distort the virtual imagery as part of the interactive experience.

In certain instances, the position of the projector 160, the reflective element 164, and/or the transmissive element 162 may be adjusted. For example, adjusting an angle between the projector 160 and the reflective element 164 may adjust a location of the virtual imagery as reflected off the screen 104. The position of the reflective element 164 in the vertical direction 114 may be adjusted to improve visibility of the virtual imagery as reflected off the screen 104. In an instance, moving the reflective element 164 downwards in the vertical direction 114 may increase a distance between the projector 160 and the reflective element 164, which may increase a size of the virtual imagery. In another example, the transmissive element 162 may be coupled to an actuator (e.g., the actuator 101 described with respect to FIGS. 2 and 3) and the position of the transmissive element 162 may be adjusted in the lateral direction 112. Adjusting the position of the transmissive element 162 may adjust an angle 109 between the transmissive element 162 and the screen 104, which may affect visibility of the virtual imagery with respect to the guest's perspective.

In certain instances, the reflective element 164 may be coupled to an actuator, such that position of the reflective element 164 may be adjusted. For example, a distance between the reflective element 164 and the display system 100 may be increased or decreased. In another example, an angle between the reflective element 164 and the display system 100 may be adjusted. The distance and/or the angle between the reflective element 164 and the display system 100 may affect a size of the virtual imagery, a location of the virtual imagery being reflected off the screen 104, and the like. As such, the show effect system 60 may improve visibility of the virtual imagery with respect to the guest's perspective.

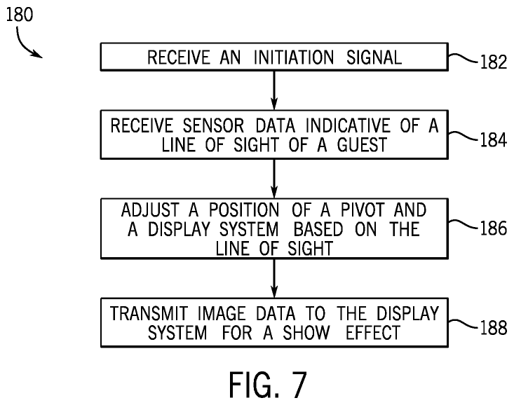

FIG. 7 is a flowchart of a method 180 for operating the show effect system 60 to generate the show effect. Any suitable device (e.g., the processor 66 of the controller 62 illustrated in FIGS. 1-6 in coordination with other system components) may perform the respective methods. In an embodiment, each method step may be implemented by executing instructions stored in a tangible, non-transitory, computer-readable medium (e.g., the memory 64 of the controller 62 illustrated in FIGS. 1-6). For example, each method step may be performed at least in part by one or more software component(s), one or more software application(s), and the like. While the method 180 is described using operations in a specific sequence, additional operations may be performed, the described operations may be performed in different sequences than the sequence illustrated, and/or certain described operations may be skipped or not performed altogether.

At block 182, the controller 62 may receive an initiation signal. For example, the initiation signal may be generated based on the ride vehicles location (e.g., exiting a tunnel), ride duration, operations (e.g., dynamic user input) occurring at different points of a ride cycle, or the like. In another example, an operator may input the initiation signal. The controller 62 may transmit a control signal to a show effect system 60 in response to receiving the initiation signal. For example, the control signal may cause the show effect system 60 to transition from a first configuration 140A to a second configuration 140B to provide a show effect to the guest 54 or to stow equipment for efficiency purposes. For example, the first configuration 140A of the show effect system 60 may be closed to reduce an amount of space (e.g., in the lateral direction) occupied by the ride vehicle 58 when traversing a ride path. The second configuration 140B of the show effect system 60 may be opened to provide the show effect, such as projecting virtual imagery to the guest. Partially extended and partially retracted configurations (e.g., the third configuration 140C) may also be initiated and employed.

At block 184, the controller 62 may receive sensor data indicative of a line of sight of a guest 54. For example, one or more sensor(s) may generate sensor data indicative of guest attributes. The controller 62 may receive the sensor data and determine a position of the guest 54 relative to the window, a height of the guest 54, facial features of the guest 54, and the like. Based on the sensor data, the controller 62 may determine the line of sight of the guest 54, such as based on the height of the guest 54, the eye level of the guest 54, the position of the guest 54 relative to the window, and the like. In another example, the controller 62 may determine a perception of the guest 54 based on an eye level and/or facial features of the guest 54. Still in another example, the sensor data may track an eye movement of the guest 54 and the controller 62 may determine the line of sight based on the eye movement.

At block 186, the controller 62 may adjust a position of a pulley and a display system 100 based on the line of sight. The controller 62 may transmit a control signal to an actuator to adjust a position of the display system 100 and the pivot 102 to move downwards in the vertical direction to adjust positioning of the screen 104. For example, the display system 100 may be extended in a lateral direction 112 with respect to the ride vehicle 58 and the screen 104 may also be extended in the lateral direction 112. In an embodiment, the display system 100 may be partially extended such that a portion of the display system 100 may project the virtual imagery and a portion of the display system 100 may be within the ride vehicle 56. As such, an amount of space occupied by the show effect system 60 may decrease. In certain instances, the controller 62 may adjust an angle 109 between the display system 100 and the screen 104 to improve visibility of the virtual imagery. For example, the controller 62 may instruct the pivot to adjust an orientation of the screen 104 to be at an angle (e.g., 45 degrees) 109 with respect to the guest's perspective. In addition, the angle 109 between the screen 104 and the display system 100 may be 45 degrees or the like to reduce distortion of the virtual imagery with respect to the guest's perspective.

At block 188, the controller 62 may transmit image data to the display system 100 for a show effect. The image data may be projected by the display system 100 and reflected off the screen 104 as virtual imagery with respect to the guest's perspective. In certain instances, the virtual imagery may be projected in a target location onto the screen 104 such that the reflected virtual imagery may align with the guest's perspective. In another example, the display system 100 may include the rear projector (e.g., projector 160 described with respect to FIG. 4) that projects the virtual imagery onto curved, reflective surface (e.g., reflective element 164) and reflected off the screen 104. In certain instances, the controller 62 may continuously update and transmit the image data to be viewed as virtual imagery by the guest 54. As such, the show effect system 60 may provide virtual imagery to the guest to provide an interactive and immersive experience.

In certain instances, the controller 62 may transmit control signal to cause the show effect system to transition from the second configuration back to the first configuration and transmit an additional control signal to cause the ride vehicle 58 to continue traversing through the ride 56. It should be noted that the method 180 may be continually or repeatedly performed. For example, the controller 62 may periodically receive the initiation signal and cause show effect system 60 to transition from one configuration to a different configuration to provide the show effect, receive sensor data to adjust the show effect system 60, and transmit the image data to generate the show effects. In addition, the show effect system 60 may adjust and update the image data to provide an immersive experience for the guest 54, such as interactive game play during the ride 56.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A show effect system for an amusement park, comprising:
a display system configured to couple with a ride vehicle and configured to transition between an extended configuration and a retracted configuration;
a screen coupled to the display system, wherein the screen is configured to:
move with the display system between the extended configuration and the retracted configuration; and
reflect imagery from the display system in the extended configuration; and
a controller in communication with an actuator, wherein the controller comprises a memory and one or more processors, and wherein the controller is configured to perform operations comprising:
instructing the actuator to adjust an angle between the screen and the display system.

2. The show effect system of claim 1, comprising a pivot integrated with or coupled to the ride vehicle, wherein the display system and the screen are coupled to the pivot.

3. The show effect system of claim 1, wherein the screen comprises a beam splitter configured to reflect the imagery from the display system toward a viewing port in a partially extended configuration of the display system.

4. The show effect system of claim 1, comprising a receptacle within the ride vehicle, wherein the receptacle is configured to house at least a portion of the display system in the retracted configuration.

5. The show effect system of claim 1, wherein the display system is configured to fold against the ride vehicle in the retracted configuration.

6. The show effect system of claim 1, wherein the display system comprises an accordion structure configured to unfold into the extended configuration and fold into the retracted configuration.

7. The show effect system of claim 1, comprising a spool configured to store at least a portion of the screen and configured to facilitate extension from and retraction of the screen from the spool.

8. The show effect system of claim 7, comprising a pivot coupled to the spool or the spool couples the screen to the display system.

9. The show effect system of claim 1, comprising one or more sensors configured to generate sensor data indicative guest characteristics or guest activity for one or more guests within the ride vehicle.

10. The show effect system of claim 9, wherein the controller is configured to:
determining a line of sight for the one or more guests within the ride vehicle based on the sensor data; and
instructing one or more actuators to adjust positioning of the display system or positioning of the screen based on the line of sight.

11. The show effect system of claim 9, wherein the controller is configured to:
determine a movement of the one or more guests based on the sensor data;
determine if the movement of the one or more guests matches one or more stored movements associated with a show effect;
generate the show effect based on the movement; and
instruct the display system to display the show effect.

12. The show effect system of claim 1, wherein the controller is configured to:
determine a target angle between the display system and the screen based on determining a line of sight for one or more guests on the ride vehicle; and
adjust a position of the screen by instructing the actuator to reduce the angle between the display system and the screen.

13. The show effect system of claim 1, wherein the controller is configured to:
receive sensor data indicative of a lateral distance between the show effect system and an obstacle; and
instruct at least one actuator to adjust positioning of the display system between the extended configuration and the retracted configuration based on the lateral distance.

14. A non-transitory computer-readable medium, comprising instructions that, when executed by one or more processors, are configured to cause the one or more processors to perform operations comprising:
determine one or more characteristics of a guest within a ride vehicle based on sensor data from one or more sensors of a show effect system;
receive an initiation signal to transition the show effect system from a retracted configuration to an extended configuration or from the extended configuration to the retracted configuration;
instruct the show effect system to transition by activating an actuator to adjust an orientation or a position of a display system based on the sensor data, wherein adjustment of the display system adjusts an orientation or a position of a beam splitter coupled to the display system;
generate image data based on the one or more characteristics of the guest; and
instruct the display system to project the image data for reflection off the beam splitter based on the image data to cause virtual imagery to be visible to the guest.

15. The non-transitory computer-readable medium of claim 14, wherein instructing the actuator to adjust the position or the orientation of the display system comprises:
activating the actuator to fold or unfold the display system.

16. The non-transitory computer-readable medium of claim 15, wherein instructing the actuator to adjust the position or the orientation of the display system comprises:
instructing the actuator to fold or unfold the display system, wherein the display system comprises an accordion structure.

17. The non-transitory computer-readable medium of claim 14, wherein the instructions, when executed by the one or more processors, are configured to cause the one or more processors to perform operations comprising:
determining a line of sight for the guest within the ride vehicle based on the sensor data; and
instructing the actuator to adjust the position or the orientation of the display system based on the line of sight.

18. An attraction system within an amusement park, comprising:
a show effect system coupled to a ride vehicle, wherein the show effect system comprises:
a beam splitter configured to reflect imagery;
a display system coupled to the ride vehicle, an actuator, and the beam splitter, wherein the actuator is configured to transition the display system between a first configuration relative to the ride vehicle and a second configuration relative to the ride vehicle; and
at least one sensor configured to generate sensor data indicative of at least one characteristic of a guest; and
a controller comprising a memory and a processor, wherein the controller is communicatively coupled to the show effect system, the controller configured to:
determine a line of sight of the guest based on the sensor data;
generate image data based on the sensor data; and
instruct the display system to present the image data as imagery for reflection off the beam splitter.

19. The attraction system of claim 18, wherein the ride vehicle comprises:
a receptacle configured to house at least a portion of the display system in the first configuration; or
a pivot coupled to the beam splitter and configured to store at least a portion of the beam splitter.

20. The attraction system of claim 18, wherein the controller is configured to activate the actuator to transition the display system from the first configuration to the second configuration based on the ride vehicle entering a designated portion of a ride path.
